(19) United States
(12) Patent Application Publication
(10) Pub. No.: US 2007/0005652 A1
(43) Pub. Date: Jan. 4, 2007

(54) Apparatus and method for gathering of objectional web sites

(75) Inventors: Su Gil Choi, Daejeon-city (KR); Chi Yoon Jeong, Gyeongsangnam-do (KR); Seung Wan Han, Gwangjoo-city (KR); Taek Yong Nam, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/386,572

(22) Filed: Mar. 21, 2006

(30) Foreign Application Priority Data
Jul. 2, 2005 (KR) 10-2005-0059481
Aug. 16, 2005 (KR) 10-2005-0074851

(51) Int. Cl. G06F 17/00

(52) U.S. Cl. 707/104.1

(57) ABSTRACT

An apparatus and method for collecting harmful web sites are provided. In the apparatus, a start uniform resource locator (URL) database (DB) stores URLs of harmful web pages. A URL examination and distribution unit provides URLs grouped in relation to predetermined hosts, the URLs obtained by removing redundant URLs that are different to each other but indicate identical web pages, among the URLs stored in the start URL DB, and then among the remaining URLs, removing URLs corresponding web sites already collected. A web site collection unit collects web contents of the web sites corresponding to the URLs received from the URL examination and distribution unit. A URL extraction unit extracts URLs in the links included in the web contents collected by the web site collection unit, identifies harmless URLs based on top-level domain names and a harmless URL list among the extracted URLs, and removes the identified harmless URLs from the URLs that are the object of the collection. According to the apparatus and method, the harmful site database is helped to maintain accurate, abundant, and latest information.

### CROSS-REFERENCE TO RELATED PATENT APPLICATIONS

This application claims the benefit of Korean Patent Application No. 10-2005-0074851, filed on Aug. 16, 2005, and Korean Patent Application No. 10-2005-0059481, filed on Jul. 2, 2005, in the Korean Intellectual Property Office, the disclosure of which is incorporated herein in its entirety by reference.

### BACKGROUND OF THE INVENTION

1. Field of the Invention

The present invention relates to a harmful site collection apparatus and method, and more particularly, to a harmful site collection apparatus and method that are applied to a system for building a harmful site database so that the collection rate and amount of harmful sites can be increased to contribute to enhancement of the collection speed and automatic classification.

2. Description of the Related Art

Technologies to block access to harmful sites can be broken down into two types: determining harmfulness by analyzing contents of a site in real time and preventing access to harmful sites by using a harmful site database. Most of harmful site blocking products currently used employ the method preventing access to harmful sites by using harmful databases, and this method is more convenient and effective than the method of analyzing contents in real time.

Harmful sites have been appearing continuously and changes of contents and addresses of the site happen frequently. Accordingly, maintaining a harmful site database by persons is difficult and time consuming. To solve this problem, a system determining the contents of a site through automatic analysis and applying the result to a harmful database is needed.

In order to analyze the contents of a site, the site information should be collected first and for this, a web robot collects a site automatically. However, it is not appropriate to use an ordinary web robot in a system for automatic classification of harmful sites. Even though a harmful site address is given as a start uniform resource locator (URL), to the ordinary web robot, the ordinary web robot will soon lose its way and begin to collect information on all sites connected to a current site. In this case, the collecting time and the space required for storing the collected web pages increase exponentially, and the time taken for analyzing the collected sites to determined harmfulness also increases. If the collection and analysis takes much time, a period of updating a harmful database becomes longer and the number of harmful sites that are not blocked because of the increasing period increases. Also, since the ordinary web robot collects only web pages in a site, it cannot provide useful information capable of enhancing the accuracy of classification of harmful sites.

In the conventional method to enhance the collection rate of harmful sites, site information is collected only when harmful keywords are included in the contents of web sites retrieved by referring to a the harmful keyword database. Accordingly, the probability that harmful sites are not collected or harmless sites are collected is very high.

### SUMMARY OF THE INVENTION

The present invention provides an apparatus and method enabling establishment of a harmful site database having accurate and abundant information, by automatically determining harmfulness of Internet sites and applying the result to a unit for automatically collecting harmful sites of a system to establish the harmful site database.

According to an aspect of the present invention, there is provided a harmful site collection apparatus including: a start uniform resource locator (URL) database (DB) storing URLs of harmful web pages; a URL examination and distribution unit providing URLs grouped in relation to predetermined hosts, the URLs obtained by removing redundant URLs that are different to each other but indicate identical web pages, among the URLs stored in the start URL DB, and then among the remaining URLs, removing URLs corresponding to web sites already collected; a web site collection unit collecting web contents of the web sites corresponding to the URLs received from the URL examination and distribution unit; and a URL extraction unit extracting URLs in the links included in the web contents collected by the web site collection unit, identifying harmless URLs based on top-level domain names and a harmless URL list among the extracted URLs, and removing the identified harmless URLs from the URLs that are the object of the collection.

According to another aspect of the present invention, there is provided a harmful site collection method including: removing redundant URLs that are different to each other but indicate identical web pages, among URLs stored in a start URL DB, then removing URLs corresponding to web sites already collected among the remaining URLs, then dividing the URLs into groups in relation to predetermined hosts and providing the groups of URLs; collecting web contents of the web sites corresponding to the arranged URLs and based on a characteristic pattern that occurs when a harmful site is accessed, analyzing whether or not the web site is harmful; and extracting URLs from links included in the collected web contents, identifying harmless URLs among the extracted URLs, based on top-level domain names and a harmless URL list, and removing the identified harmless URLs from the URLs that are the object of the collection.

According to the apparatus and method, the harmful site database is helped to maintain accurate, abundant, and latest information.

### BRIEF DESCRIPTION OF THE DRAWINGS

The above and other features and advantages of the present invention will become more apparent by describing in detail exemplary embodiments thereof with reference to the attached drawings in which:

FIG. 1A illustrates the structure of a preferred embodiment of a site collecting apparatus according to the present invention;

FIG. 1B illustrates the structure of a preferred embodiment of a harmful site collecting apparatus according to the present invention;

FIG. 2 is a detailed diagram of a preferred embodiment of a harmful URL meta search unit of a harmful site collecting apparatus according to the present invention;

FIG. 3 is a detailed diagram of a preferred embodiment of a URL examination and distribution unit of a harmful site collecting apparatus according to the present invention;

FIG. 4 is a detailed diagram of a preferred embodiment of a web site collection unit of a harmful site collecting apparatus according to the present invention;

FIG. 5 is a detailed diagram of a preferred embodiment of a harmless image filter of a harmful site collecting apparatus according to the present invention;

FIG. 6 is a detailed diagram of a preferred embodiment of a URL extraction unit of a harmful site collecting apparatus according to the present invention; and

FIG. 7 is a flowchart of a harmful site collection method according to a preferred embodiment of the present invention.

### DETAILED DESCRIPTION OF THE INVENTION

The present invention will now be described more fully with reference to the accompanying drawings, in which exemplary embodiments of the invention are shown.

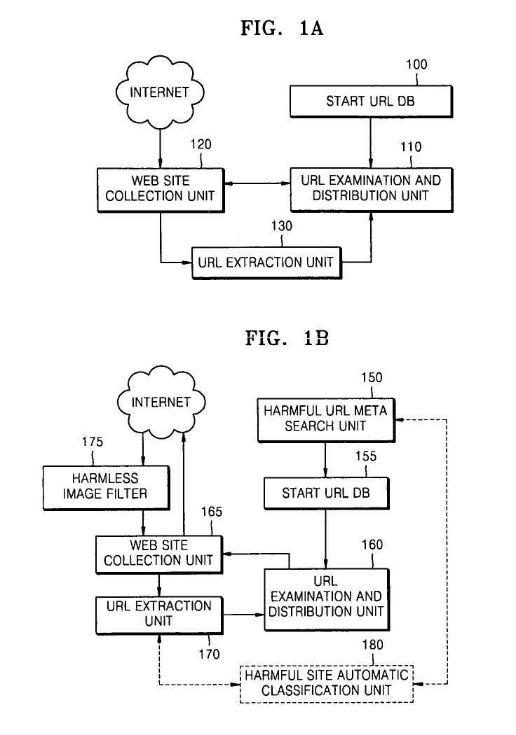

FIG. 1A illustrates the structure of a preferred embodiment of a site collecting apparatus according to the present invention.

Referring to FIG. 1A, a site collection apparatus includes a start URL DB 100, a URL examination and distribution unit 110, a web site collection unit 120 and a URL extraction unit 130.

The start URL DB 100 stores URLs from which a web robot begins to collect information. The URL examination and distribution unit 110 extracts start URLs of predetermined hosts from the start URL DB 100 and transfers the URLs to the web site collection unit 120.

The web site collection unit 120 collects web pages included in sites of the URLs of the predetermined hosts transferred by the URL examination and distribution unit 110 and transfers the collected result to the URL extraction unit 130.

The URL extraction unit 130 extracts URLs in the links included in the received web pages and transfers the URLs to the URL examination and distribution unit 110. Then, the URL examination and distribution unit 110 examines the redundancy of URLs (that is, different URLs indicating an identical web page) and whether or not a URL is already collected, and stores only URLs that are objects of the collection. The processes of web site information collection, URL extraction, and URL examination and distribution are repeated continuously until there is no more URL to be collected.

FIG. 1B illustrates the structure of a preferred embodiment of a harmful site collecting apparatus according to the present invention.

Referring to FIG. 1B, the harmful site collection apparatus according to the present invention includes a harmful URL meta search unit 150, a start URL DB 155, a URL examination and distribution unit 160, a web site collection unit 165, a URL extraction unit 170, and a harmless image filter 175.

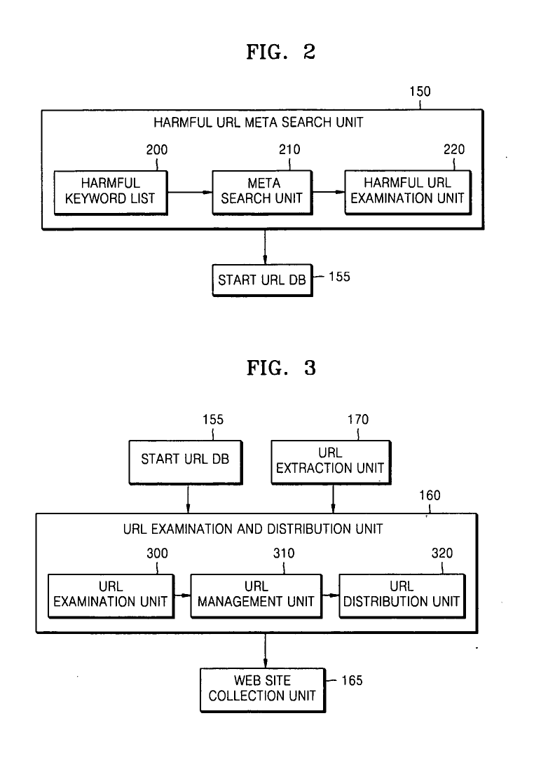

The harmful URL meta search unit 150 collects URLs of web pages having a high probability of being harmful, by using harmful keywords as inputs of meta search, and stores URLs that are determined to be harmful by a harmful site automatic classification unit 180, in the start URL DB 155. The start URL DB 155 is the same as that in an ordinary web robot. The harmful URL meta search unit 150 will be explained later in more detail with reference to FIG. 2.

The URL examination and distribution unit 160 examines the redundancy of URLs (that is, URLs corresponding to an identical web page) and whether or not the URLs correspond to a URL that is already collected, and stores only URLs that are objects of the collection. Then, the URL examination and distribution unit 160 deletes URLs for which the URL extraction unit 170 transmits a delete command. The URL examination and distribution unit 160 will be explained later in more detail with reference to FIG. 3.

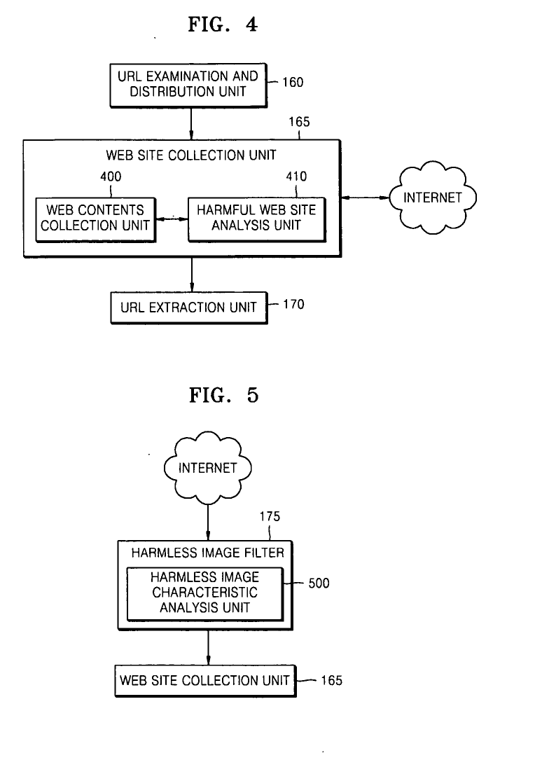

The web site collection unit 165 receives the collected URLs transferred by the URL examination and distribution unit 160, and by requesting web pages corresponding to the URLs to web servers on the Internet, collects the web pages and identifies characteristics that can appear when harmful web site information is collected. The web site collection unit 165 will be explained below in more detail with reference to FIG. 4.

The harmless image filter 175 compares web contents (images) that the web site collection unit 165 is going to collect, with a harmless image characteristic profile, and if the contents have the characteristic of harmless images, blocks collection by the web site collection unit 165. The harmless image characteristic profile is set in advance by identifying the characteristic pattern of the harmless images. The harmless image filter 175 will be explained later in more detail with reference to FIG. 5.

The URL extraction unit 170 extracts URLs included in the web pages collected by the web site collection unit 165, and by using a harmless URL list and harmless top-level domain names (that is, edu, gov, org, etc.), removes harmless URLs among the extracted URLs, and then, transfers the result to the URL examination and distribution unit 160.

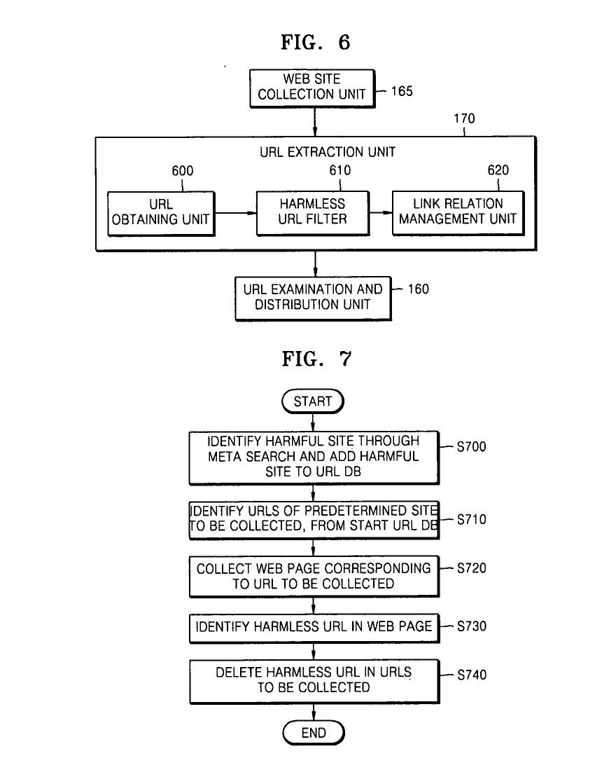

Also, the URL extraction unit 170 receives the classification result of each site from the external harmful site automatic classification unit 180, identifies harmless sites, and based on the result, transfers a delete command to delete URLs corresponding to harmless sites, to the URL examination and distribution unit 160. The URL extraction unit 170 will be explained later in more detail with reference to FIG. 6.

Here, the harmful site automatic classification unit 180 is an apparatus analyzing whether a web page include harmful contents by identifying the characteristic of the web page, and can be implemented automatically or manually. The harmful site automatic classification unit can be implemented by using a conventional element.

FIG. 2 is a detailed diagram of a preferred embodiment of the harmful URL meta search unit 150 of a harmful site collecting apparatus according to the present invention.

Referring to FIG. 2, the harmful URL meta search unit 150 includes a harmful keyword list 200, a meta search unit 210, and a harmful URL examination unit 220.

The harmful keyword list 200 is a list arranging representative words that frequently appear in harmful sites. The meta search unit 210 sends a search request for words in the harmful keyword list 200, in a predetermined search engine, and receives the search result. Even though harmful keywords are input in the search engine, many URLs of harmless web pages can be included in the search result.

Accordingly, the harmful URL examination unit 220 removes URLs found in the previous search, and in interoperation with the harmful site automatic classification unit 180, stores only URLs of harmful web pages. By doing so, only newly appearing URLs can be identified. The harmful URL meta search unit 150 stores the harmful URLs identified by the method described above, in the start URL DB.

FIG. 3 is a detailed diagram of a preferred embodiment of a URL examination and distribution unit of a harmful site collecting apparatus according to the present invention.

Referring to FIG. 3, the URL examination and distribution unit 160 includes a URL examination unit 300, a URL management unit 310, and a URL distribution unit 320.

The URL examination unit 300 removes redundancy, by identifying URLs that indicate identical web pages and are redundantly included, among URLs that are the object of the examination, and by comparing the URLs with a list of already collected sites, removes URLs related to the already collected sites so that only URLs that are the object of the collection can be arranged. The method of determining the redundancy of URLs may include a method of determining whether or not URLs have an identical IP address, by examining IP addresses, or a method of determining whether or not web pages corresponding to URLs are identical, by comparing the web pages.

In the list of the arranged URLs that are the object of the collection, the URL management unit 310 deletes URLs for which the URL extraction unit 170 sends a delete command.

If a URL request from the web site collection unit is received, the URL distribution unit 320 groups URLs in the list of URLs to be collected, with respect to predetermined hosts, and transfers the groups to the web site collection unit 165.

FIG. 4 is a detailed diagram of a preferred embodiment of the web site collection unit of the harmful site 165 collecting apparatus according to the present invention.

Referring to FIG. 4, the web site collection unit 165 includes a web contents collection unit 400, and a harmless web site analysis unit 410.

The web contents collection unit 400 collects web contents corresponding to the URL list received from the URL examination and distribution unit 160, by requesting the contents from web servers, and if there is a link in the collected web contents, to other web contents in the identical web site, also collects the other web contents connected by the link.

The harmful web site analysis unit 410 emulates a process for parsing and processing web pages collected by the web contents collection unit 400 through a web browser, identifies characteristics that occurs when the web pages of the harmful site are received, parsed, and processed, and stores the identified result. For example, redirection occurs many times when a main page of a harmful web site is accessed through a web browser, and this phenomenon can be regarded as the characteristic that occurs when a harmful web site is collected. If this information can be utilized when the harmful web site automatic classification unit 180 determines whether or not a web site is harmful, the classification performance can be enhanced.

FIG. 5 is a detailed diagram of a preferred embodiment of the harmless image filter 175 of a harmful site collecting apparatus according to the present invention.

Referring to FIG. 5, the web contents requested by the web site collection unit 165 passes through the harmless image filter 175. If the web contents are images, the harmless image characteristic analysis unit 500 compares the characteristic of the images with a harmless image characteristic profile, and if the images are determined to be harmless, sends a signal notifying that the images are harmless.

FIG. 6 is a detailed diagram of a preferred embodiment of the URL extraction unit 170 of a harmful site collecting apparatus according to the present invention.

Referring to FIG. 6, the URL extraction unit 170 includes a URL obtaining unit 600, a harmless URL filter 610, and link relation management unit 620.

The URL obtaining unit 600 extracts URLs in the links included in the web pages collected by the web site collection unit 165. The harmless URL filter 610 removes URLs that can be identified to be harmless through only the URLs themselves, among the URLs extracted by the URL obtaining unit 600. That is, the harmless URL filter 610 removes URLs included in the harmless URL list and if URL domain names correspond to harmless top-level domain names (that is, edu, gov, org, etc.), removes the URLs in the URLs that are the object of the collection, and then transfers the remaining URLs to the URL examination and distribution unit 160.

The link relation management unit 620 maintains link relation information between sites, and identifies sites linked to harmless sites. That is, the link relation management unit 620 determines that sites linked to a site determined to be harmless as the result of harmful site automatic classification, are harmless. The link relation management unit 620 transfers the harmless site list to the URL examination and distribution unit 160 so that the harmless URLs can be deleted in the URL list to be collected.

For example, if site A is linked to sites B, C, and D, and site B is linked to sites E and F, and site E is linked to sites G and H, and it is determined that site B is harmless, sites E, F, G and H that are linked from site B are regarded as harmless and will not be collected.

FIG. 7 is a flowchart of a harmful site collection method according to a preferred embodiment of the present invention.

Referring to FIG. 7, harmful sites are identified through meta search and stored in a start URL DB in operation S700. In the URLs stored in the start URL DB and having probabilities of being harmful, the redundancy of URLs corresponding to identical web pages is removed. Then, in the URLs obtained after removing the redundancy, URLs corresponding to web sites already collected are removed, and the remaining URLs are rearranged and divided into groups with respect to predetermined hosts in operation S710.

Web contents of web sites corresponding to URLs included in a predetermined host are collected in operation S720, and based on a characteristic pattern that occurs when a harmful web site is accessed, it is analyzed whether or not a web site to be collected is harmful in operation S730.

URLs are extracted from links included in the web contents of the collected web sites, and harmless URLs are identified in the extracted URLs based on the domain names of the URLs and a harmless URL list, and removed from a URL DB in operation S740.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

According to the present invention, whether or not Internet sites are harmful is automatically determined and the present invention can be applied to a unit for automatically collecting harmful sites of a system to establish a harmful site database.

Also, reduction of an update period of a harmful site database, increase in the number of harmful sites included in the database, and enhancement of accuracy of the database are enabled such that satisfaction of a harmful site blocking service can be increased.

While the conventional harmful site collection technologies are only addition of a harmful keyword matching method to the ordinary web robot technology, and cannot help much the improvement of the quality and quantity of a harmful database, the present invention improves much of the harmful site collection method and can provide a direct help to the improvement of the quantity and quality of a harmful site database.

What is claimed is:

1. A harmful site collection apparatus comprising:
a start uniform resource locator (URL) database (DB) storing URLs of harmful web pages;
a URL examination and distribution unit providing URLs grouped in relation to predetermined hosts, the URLs obtained by removing redundant URLs that are different to each other but indicate identical web pages, among the URLs stored in the start URL DB, and then among the remaining URLs, removing URLs corresponding to web sites already collected;
a web site collection unit collecting web contents of the web sites corresponding to the URLs received from the URL examination and distribution unit; and
a URL extraction unit extracting URLs in the links included in the web contents collected by the web site collection unit, identifying harmless URLs based on top-level domain names and a harmless URL list among the extracted URLs, and removing the identified harmless URLs from the URLs that are the object of the collection.

2. The apparatus of claim 2, wherein the web site collection unit determines whether or not a characteristic pattern that occurs when the web site is accessed is similar to a characteristic pattern that occurs when a harmful site is accessed.

3. The apparatus of claim 1, wherein the URL extraction unit identifies, as harmless URLs, URLs linked from harmless URLs identified by an external harmful site automatic classification unit.

4. The apparatus of claim 1, further comprising:
a harmful URL meta search unit identifying the URL of a web site that is highly probable to be harmful, by using a harmful keyword as an input for meta search.

5. The apparatus of claim 4, wherein the harmful URL meta search unit comprises:
a harmful keyword list including harmful keywords that appear frequently in harmful sites;
a meta search unit using the harmful keywords as inputs of search engines and extracting URLs included in the search results by the search engines; and
a URL examination unit storing only the URLs included in the search result, excluding harmless URLs, in the URL DB.

6. The apparatus of claim 1, further comprising:
a harmless image filter, if the contents of a web page collected by the web site collection unit are images, comparing the characteristic of the images with a preset harmless image characteristic profile, and blocking collection of harmless images.

7. The apparatus of claim 1, wherein the URL examination and distribution unit comprises:
a URL examination unit removing redundant URLs that are different to each other but indicate identical web pages, among the URLs stored in the start URL DB, and then removing URLs corresponding to web sites already collected, to arrange URLs that are the object of the collection;
a URL management unit deleting URLs that are determined to be harmless by the URL extraction unit, in the URLs that are the object of the collection; and
a URL distribution unit dividing the URLs that are the object of the collection, into groups in relation to predetermined hosts, and transferring the URLs.

8. The apparatus of claim 1, wherein the web site collection unit comprises:
a web contents collection unit receiving a list of URLs included in a predetermined host from the URL examination and distribution unit, and collecting web contents corresponding to the received URL list; and
a web site analysis unit identifying whether or not a characteristic pattern that occurs when a harmful web site is accessed occurs when the web contents are collected.

9. The apparatus of claim 1, wherein the URL extraction unit comprises:
a URL obtaining unit extracting URLs from links included in the web contents collected by the web site collection unit;
a harmless URL filter identifying harmless URLs among the extracted URLs, based on top-level domain names and a harmless URL list; and
a link relation management unit identifying the URLs of sites linked from harmless URLs identified by an external harmful site automatic classification unit, as harmless URLs, and then requesting the URL examination and distribution unit to delete the URLs identified to be harmless.

10. A harmful site collection method comprising:
removing redundant URLs that are different to each other but indicate identical web pages, among URLs stored in a start URL DB, then removing URLs corresponding to web sites already collected among the remaining URLs, then dividing the URLs into groups in relation to predetermined hosts and providing the groups of URLs;
collecting web contents of the web sites corresponding to the arranged URLs and based on a characteristic pattern that occurs when a harmful site is accessed, analyzing whether or not the web site is harmful; and
extracting URLs from links included in the collected web contents, identifying harmless URLs among the extracted URLs, based on top-level domain names and a harmless URL list, and removing the identified harmless URLs from the URLs that are the object of the collection.

11. The method of claim 10, wherein the collecting of the web contents and analyzing whether or not the web site is harmful include:
determining whether or not the characteristic pattern that occurs when the web site is accessed is similar to the characteristic pattern that occurs when a harmful site is accessed.

12. The method of claim 10, wherein the extracting of the URLs from links and the identifying of the harmless URLs include:
identifying the URLs of sites linked to a predetermined harmless URL, as harmless URLs.

13. The method of claim 10, further comprising before the removing the redundant URLs:
identifying URLs of web sites having high probabilities of being harmful, by using harmful keywords as input of meta search, and storing the URLs in the URL DB.

14. The method of claim 10, wherein the collecting of the web contents and analyzing whether or not the web site is harmful include:
if the collected contents of the web page are images, blocking collection of harmless image, by comparing the characteristic of the images with a preset harmless image characteristic profile.
